(19) United States
(12) Patent Application Publication
(10) Pub. No.: US 2015/0242118 A1
(43) Pub. Date: Aug. 27, 2015

(54) METHOD AND DEVICE FOR INPUTTING

(71) Applicant: Xiaomi Inc., Beijing (CN)

(72) Inventor: Xu Zhang, Beijing (CN)

(21) Appl. No.: 14/515,548

(22) Filed: Oct. 16, 2014

Related U.S. Application Data
(63) Continuation of application No. PCT/CN2014/084359, filed on Aug. 14, 2014.

(30) Foreign Application Priority Data
Feb. 22, 2014 (CN) 201410063114.0

(51) Int. Cl. G06F 3/0488; G06F 3/041

(52) U.S. Cl. CPC G06F 3/04886; G06F 3/041; G06F 2203/04104

(57) ABSTRACT

The present disclosure discloses a method and a device for inputting. The method for inputting includes: receiving a tap signal through the touch screen; detecting a touch position of a target finger based on the tap signal; determining a target key button position corresponding to the target finger at the touch position, based on a displacement between an initial position and the touch position of the target finger, a basic key button position of a basic key button corresponding to the target finger at the initial position, and a relative position of the basic key button position and other key button positions of other key buttons corresponding to the target finger on the touch screen; and inputting a target character corresponding to the target key button position.

### CROSS-REFERENCE TO RELATED APPLICATIONS

This application is a Continuation application of International Application No. PCT/CN2014/084359, filed Aug. 14, 2014, which is based upon and claims priority to Chinese Patent Application No. 201410063114.0, filed Feb. 22, 2014, the entire contents of which are incorporated herein by reference.

### TECHNICAL FIELD

The present disclosure relates to the field of computer technology, and more particularly, to a method and a device for inputting.

### BACKGROUND

With the rapid development of touch screen technology, touch screens have became one of the most common human-computer interface used in electronic devices such as smart phones, tablet PCs or e-readers.

While using the electronic devices, users often need to use the touch screen to input text to the electronic devices. For example, an electronic device displays a pre-established virtual keyboard including key button positions for each character in a real physical keyboard. The electronic device receives a touch signal produced by a user on a certain key button position, and after the touch signal is received, a target character corresponding to the key button position touched by the user is inputted.

### SUMMARY

According to a first aspect of embodiments of the present disclosure, there is provided a method for inputting using a touch screen, comprising: receiving a tap signal through the touch screen; detecting a touch position of a target finger based on the tap signal; determining a target key button position corresponding to the target finger at the touch position, based on a displacement between an initial position and the touch position of the target finger, a basic key button position of a basic key button corresponding to the target finger at the initial position, and a relative position of the basic key button position and other key button positions of other key buttons corresponding to the target finger on the touch screen; and inputting a target character corresponding to the target key button position.

According to a second aspect of embodiments of the present disclosure, there is provided a device for inputting using a touch screen, comprising: a processor; and a memory for storing instructions executable by the processor, wherein the processor is configured to perform: receiving a tap signal through the touch screen; detecting a touch position of a target finger based on the tap signal; determining a target key button position corresponding to the target finger at the touch position, based on a displacement between an initial position and the touch position of the target finger, a basic key button position of a basic key button corresponding to the target finger at the initial position, and a relative position of the basic key button position and other key button positions of other key buttons corresponding to the target finger on the touch screen; and inputting a target character corresponding to the target key button position.

According to a third aspect of embodiments of the present disclosure, there is provided a non-transitory computer-readable storage medium having stored therein instructions that, when executed by a processor of a device, causes the device to perform an method for inputting, the method comprising: receiving a tap signal through the touch screen; detecting a touch position of a target finger based on the tap signal; determining a target key button position corresponding to the target finger at the touch position, based on a displacement between an initial position and the touch position of the target finger, a basic key button position of a basic key button corresponding to the target finger at the initial position, and a relative position of the basic key button position and other key button positions of other key buttons corresponding to the target finger on the touch screen; and inputting a target character corresponding to the target key button position.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart showing a method for inputting using a touch screen according to an exemplary embodiment.

FIG. 2A is a flowchart showing a method for inputting using a touch screen according to another exemplary embodiment.

FIG. 2B is a diagram showing a placement manner of a palm when obtaining natural position correlations, according to another exemplary embodiment.

FIG. 2C is a diagram showing the natural position correlations obtained by a device, according to another exemplary embodiment.

FIG. 2D is a diagram showing the device obtaining a fingerprint of a finger, according to another exemplary embodiment.

FIG. 2E is a diagram showing a placement manner of a palm when the device obtains maximal position correlations, according to another exemplary embodiment.

FIG. 2F is a diagram showing corresponding correlations between respective fingers and default characters when the palm touches the touch screen in a naturally typing state, according to another exemplary embodiment.

FIG. 2G is a diagram showing a preset ordering among various key button positions corresponding to a finger, according to another exemplary embodiment.

FIG. 2H is another flowchart showing a method for inputting using a touch screen according to another exemplary embodiment.

FIG. 3 is a diagram showing an apparatus for inputting according to an exemplary embodiment.

FIG. 4A is a diagram showing an apparatus for inputting according to another exemplary embodiment.

FIG. 4B is a diagram showing an initial position retrieving unit according to another exemplary embodiment.

FIG. 5 is a diagram showing a device for inputting according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

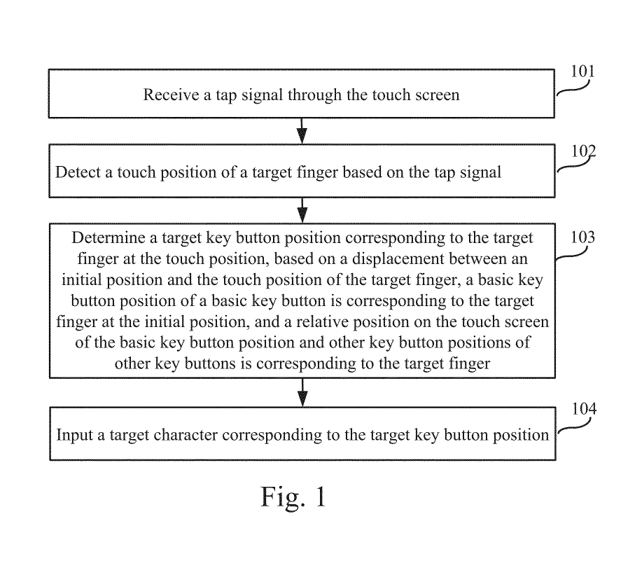

FIG. 1 is a flowchart showing a method for inputting using a touch screen according to an exemplary embodiment. As shown in FIG. 1, the method for inputting may be implemented by a device including a touch screen, and the method includes the following steps.

In step 101, a tap signal is received through the touch screen.

In step 102, a touch position of a target finger is detected based on the tap signal.

In step 103, a target key button position corresponding to the target finger at the touch position is determined based on a displacement between an initial position and the touch position of the target finger, a basic key button position of a basic key button corresponding to the target finger at the initial position, and a relative position of the basic key button position and other key button positions of other key buttons corresponding to the target finger on the touch screen.

In step 104, a target character corresponding to the target key button position is inputted.

After the tap signal is received, the method provided by the present embodiment detects the touch position of the target finger based on the tap signal, and then determines the target key button position corresponding to the target finger at the touch position based on the displacement between the initial position and the touch position of the target finger, the basic key button position of the basic key button corresponding to the target finger at the initial position, and the relative position of the basic key button position and other key button positions of other key buttons corresponding to the target finger on the touch screen, and thus inputs the target character corresponding to the target key button position, so as to solve the low input accuracy and slow input speed problems in the related art, and to achieve the following effects. Even if the placement position of the user's hands deviates from the user's normal use, because the target key button position is determined based on the displacement between the initial position and the touch position of the target finger, the device still may input the user's desired character accurately, such that the input accuracy may be improved. Meanwhile, since the target key button position is determined based on the displacement between the initial position and the touch position of the target finger, the user may conduct inputting on the touch screen according to his own touch-typing habit in the physical keyboard, without viewing the virtual keyboard on the touch screen, and thus achieving the effect of improving the input speed.

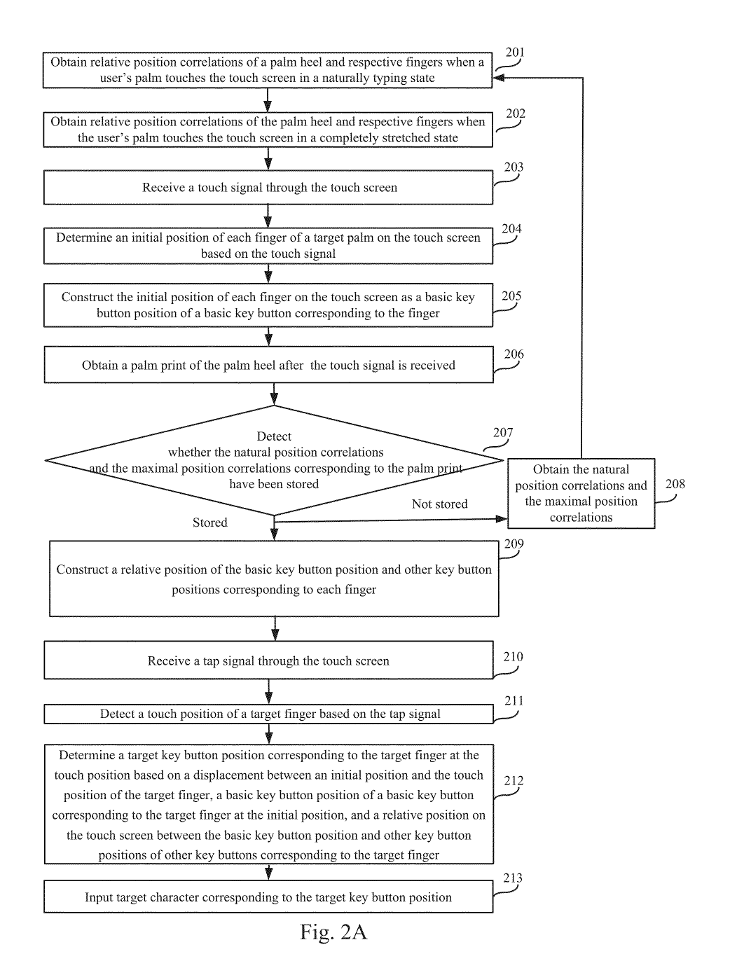

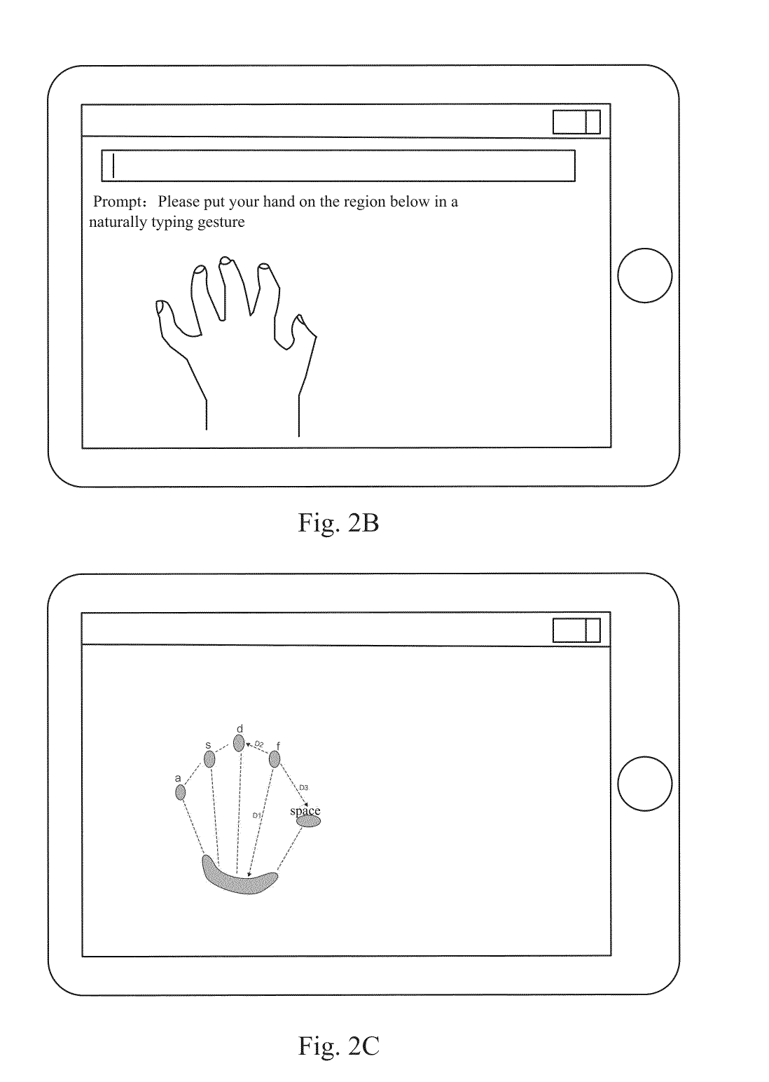

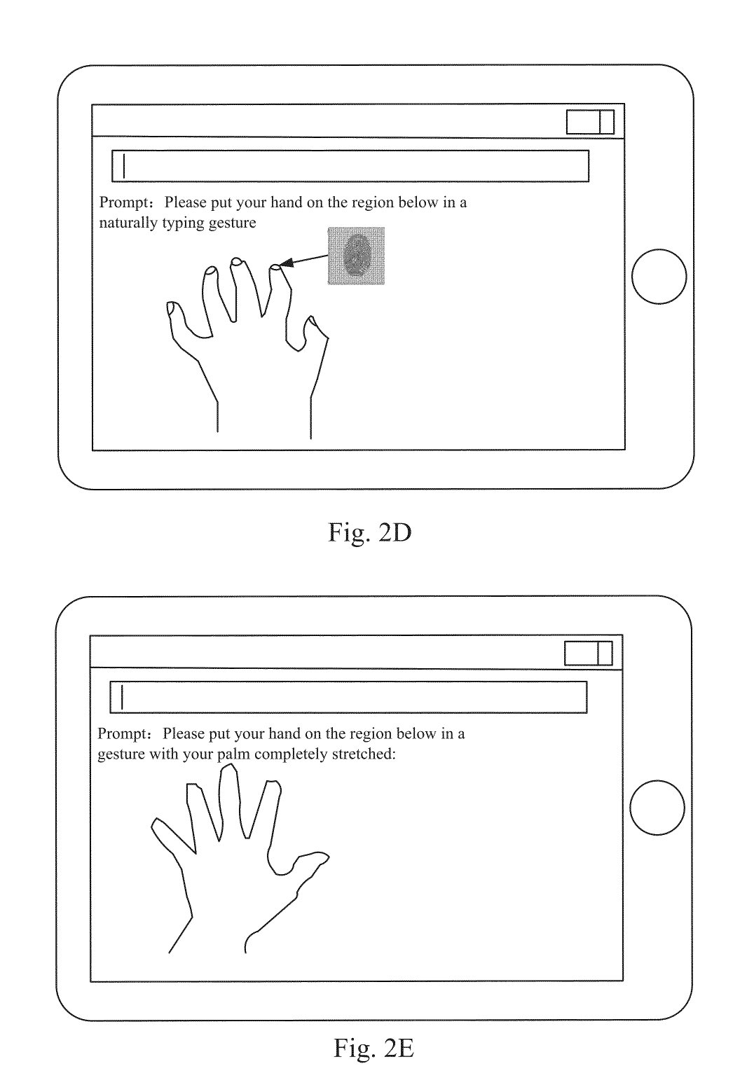

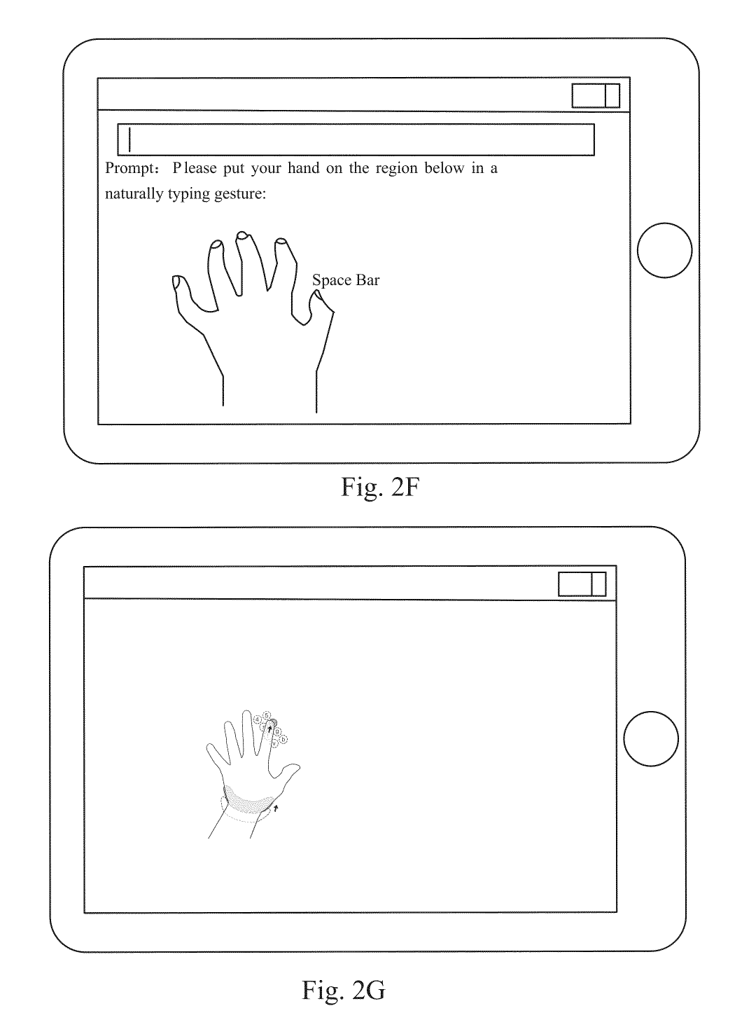

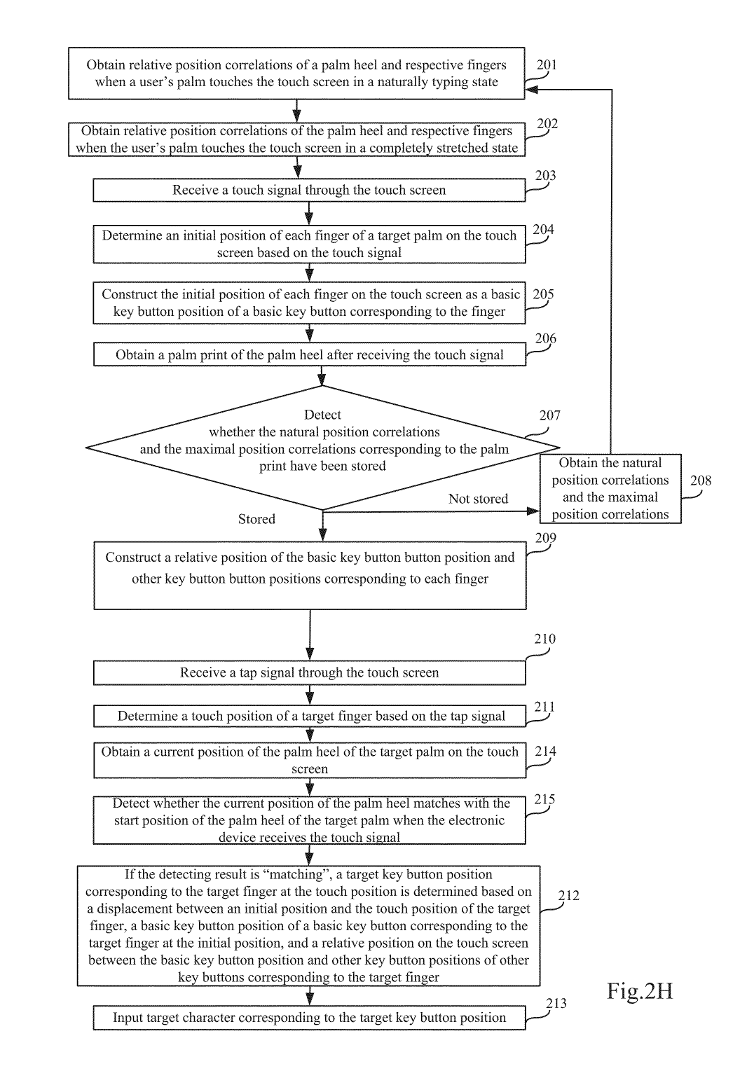

FIG. 2A is a flowchart showing a method for inputting using a touch screen according to another exemplary embodiment. As shown in FIG. 2A, the method may be implemented by a device including a touch screen, and the method includes the following steps.

In step 201, relative position correlations of a palm heel and respective fingers when a user's palm touches the touch screen in a naturally typing state are obtained.

When a user requests inputting on the device for the first time, in order to perform subsequent steps, the device may request obtaining the relative position correlations between the palm heel and respective fingers when the user's palm touches the touch screen in the naturally typing state.

In actual implementation, when the user requests inputting on the device for the first time, the device may display a display interface for prompting the user to touch the touch screen by his palm in a naturally typing state; after viewing the display interface displayed by the device, the user uses his palm to touch the touch screen in the naturally typing state shown in FIG. 2B. In this case, the device may correspondingly receive a touch signal produced when the user's palm touches the touch screen in the naturally typing state. The touch signal includes signals applied respectively by the palm heel of the user's palm and the five fingers of the palm. After the touch signal is received, the device may determine relative position correlations among receipt positions of respective signals in the touch signal as the relative position correlations among the palm heel and the five fingers of the palm, for details of which please refer to FIG. 2C.

In order to distinguish the relative position correlations between the palm heel and respective fingers when different users use their hands to touch the touch screen in the naturally typing state, the device may obtain a palm print of the palm heel and fingerprints of each of the fingers, so as to identify the palm heel by using the obtained palm print and identify the respective fingers by using the obtained fingerprints. In actual implementation, when the device obtains the palm print of the palm heel, because the outmost layer of the palm print is nonconductive, while the subcutaneous layer inside the palm is conductive, so when the user's palm falls onto the touch screen of the device, the device may detect lines of the palm print by supplying electricity to the palm skin, so as to obtain the palm print of the palm heel by measuring a tiny change in conductivity caused by the palm print, which will not be redundantly described in this embodiment. Similarly, the device may use the same method to obtain fingerprints of each fingers; for example, the electronic device may obtain the fingerprint of the finger as shown in FIG. 2D.

In step 202, relative position correlations between the palm heel and respective fingers when the user's palm touches the touch screen in a completely stretched state are obtained.

Similarly, when the user requests inputting on the device for the first time, in order to perform subsequent steps, the device may obtain the relative position correlations between the palm heel and respective fingers when the user's palm touches the touch screen in a completely stretched state.

In actual implementation, the device may use an obtaining method similar to that in step 201 to obtain the relative position correlations between the palm heel and respective fingers when the user's palm touches the touch screen in the completely stretched state. What is different from step 201 is that the user uses his palm to touch the touch screen in the completely stretched state as indicated in FIG. 2E.

It is to be noted that the present embodiment is exemplified by firstly performing step 201 and then performing step 202. In actual implementation, the device may perform step 201 and step 202 simultaneously, or firstly perform step 202 and then perform step 201, the specific performing sequence of which is not limited by the present embodiment.

In step 203, a touch signal is received through the touch screen.

When the user needs to request inputting in the device, the user may put his palm on the touch screen of the device, and then realize the inputting by taping on the touch screen with a finger, so the device may correspondingly receive the touch signal applied by the palm through the touch screen.

In step 204, an initial position of each finger of a target palm on the touch screen is determined based on the touch signal.

After the touch signal is received, the device may determine the initial position of each finger of the user's palm on the touch screen based on the touch signal, that is, the device may determine the initial position of each finger of the target palm on the touch screen based on the touch signal. The target palm is a palm to which a target finger taping the touch screen belongs. For example, when the user taps the touch screen using a finger of his left hand, the target palm is the left palm; when the user taps the touch screen using a finger of his right hand, the target palm is the right palm.

In actual implementation, the device determines the initial position of each finger of the target palm on the touch screen based on the touch signal by any one of the following manners.

In a first manner, if a palm print is used to identify the palm heel and fingerprints are used to identify respective fingers in natural position correlations, a palm print of the palm heel is obtained based on the touch signal and a start position of the palm print on the touch screen is determined, then the natural position correlations corresponding to the palm print are obtained and the initial position of each finger on the touch screen is determined based on the start position of the palm print on the touch screen and the natural position correlations.

If the palm print is used to identify the palm heel and fingerprints are used to identify respective fingers in natural position correlations, after the touch signal is received, the device may obtain the palm print of the palm heel, and provide a touch position of the palm heel upon receiving the touch signal as the start position corresponding to the palm heel on the touch screen. When the user's palm is placed in the naturally typing state, the relative positions of the palm heel and each of the fingers of the same user's palm are substantially invariable, so after obtaining the palm print of the palm heel and the start position corresponding to the palm heel on the touch screen, the device may obtain the natural position correlations corresponding to the palm print, and thus determine the initial position of each finger on the touch screen by retrieving the natural position correlations. The natural position correlations are relative position correlations between the palm heel and respective fingers when the target palm touches the touch screen in the naturally typing state.

In a second manner, if fingerprints are used to identify respective fingers in natural position correlations and/or maximal position correlations, separate fingerprints are obtained based on the touch signal after the touch signal is received, where each finger is identified based on the different fingerprints, and the initial position of each finger on the touch screen is determined based on a position of each fingerprint in the touch signal.

If fingerprints are used to identify respective fingers in the natural position correlations, the maximal position correlations or both, e.g., the fingerprints are used to identify respective fingers in the natural position correlations, after the touch signal is received, the device may obtain the fingerprints of respective fingers which apply the touch signal and the position of each fingerprint, identify different fingers based on the obtained fingerprints and the fingerprints in the natural position correlations, and thus determine the position of each fingerprint as the position of each finger on the touch screen.

In step 205, the initial position of each finger on the touch screen is constructed as a basic key button position of a basic key button corresponding to the finger.

After determining the initial position of each finger of the target palm, the device may construct the initial position of each finger as the basic key button position of the basic key button corresponding to each finger. The basic key button corresponding to each finger is the key button of default character corresponding to each finger of the palm when the user's palm touches the touch screen in the naturally typing state.

In actual implementation, similarly to the case where the user conducts inputting on a physical keyboard, when the user's palm touches the touch screen in a naturally typing state, fingers of the user's left hand sequentially correspond to basic key buttons ‘A’, ‘S’, ‘D’, ‘F’ and ‘space’ from the pinky finger to the thumb, and fingers of the user's right hand sequentially correspond to basic key buttons ‘:’, ‘L’, ‘K’, ‘J’ and ‘space’ from the pinky finger to the thumb. Therefore, after determining the initial position of each finger, the electronic device may construct the initial position of each finger as the basic key button position of the basic key button corresponding to each finger. For example, the initial position of the pinky finger of the left hand on the touch screen is constructed as the basic key button position of ‘A’ on the touch screen, and the initial position of the ring finger of the left hand on the touch screen is constructed as the basic key button position of ‘S’ on the touch screen, for details of which please refer to FIG. 2F.

In Addition, in actual implementation, the user may select a key button for each finger via setting options, and thus construct the initial position of the finger as the key button position of the user-selected key button on the touch screen, the specific constructing manner of which is not limited by the present embodiment.

In step 206, a palm print of the palm heel is obtained after receiving the touch signal.

After the device receives the touch signal, and the palm print is used to identify the palm heel in the natural position correlations and the maximal position correlations, in order to perform subsequent steps, the device obtains the palm print of the palm heel of the target palm.

It is to be noted that the present embodiment is exemplified by performing step 206 after step 204. In actual implementation, the device may perform step 206 and step 204 simultaneously, or firstly perform step 206 and then perform step 204, the specific performing sequence of which is not limited by the present embodiment.

In step 207, whether the natural position correlations and the maximal position correlations corresponding to the palm print have been stored is detected based on the palm print of the palm heel. If the detecting result is “are not stored”, then step 208 is to be performed; if the detecting result is “have been stored”, then step 209 is to be performed;

After obtaining the palm print of the palm heel, the device may detect, based on the palm print of the palm heel, whether the natural position correlations and the maximal position correlations have been stored in the device. The natural position correlations are relative position correlations between the palm heel and respective fingers when the target palm touches the touch screen in the naturally typing state. The maximal position correlations are relative position correlations between the palm heel and respective fingers when the target palm touches the touch screen in the completely stretched state.

In actual implementation, the relative position correlations between the palm heel and respective fingers when the palm touches the touch screen in the naturally typing state as well as the relative position correlations between the palm heel and respective fingers when the palm touches the touch screen in the completely stretched state are different for different users. Moreover, a method for distinguishing different users is to distinguish them by the users' palm prints. Therefore, after obtaining the palm print of the palm heel, the electronic device may detect whether the relative position correlations between the palm heel and respective fingers when the user's palm touches the touch screen in the naturally typing state as well as the relative position correlations between the palm heel and respective fingers when the palm touches the touch screen in the completely stretched state, which match with the obtained palm print of the palm heel, have been stored.

In step 208, the natural position correlations and the maximal position correlations are obtained.

If the device detects that the natural position correlations and the maximal position correlations are not stored, it is indicated that the user conducts inputting on the device for the first time, thus, at this time, the device may obtain the natural position correlations and the maximal position correlations. The device obtains the natural position correlations by the following steps.

Firstly, a first touch signal is received through a first interface, wherein the first interface is configured to prompt the user to touch the touch screen by the target palm in the naturally typing state.

When the device detects that the natural position correlations and the maximal position correlations are not stored, the device may display the first interface, which is configured to prompt the user to touch the touch screen by the target palm in the naturally typing state.

Secondly, relative position correlations between the palm heel and respective fingers when the target palm touches the touch screen in the naturally typing state are determined based on the first touch signal, and the relative position correlations determined based on the first touch signal are set as the natural position correlations.

After receiving the first touch signal, the device determines, based on the first touch signal, relative position correlations between the palm heel and respective fingers when the target palm touches the touch screen in the naturally typing state, and sets the relative position correlations determined based on the first touch signal as the natural position correlations.

It is to be noted that the device obtains the natural position correlations in an obtaining manner similar to that for the device to obtain the position correlations between the palm heel and respective fingers when the user's palm touches the touch screen in the naturally typing state in step 201, for the technical details please refer to step 201, which will not be redundantly described here.

The device obtains the maximal position correlations by the following steps.

Firstly, a second touch signal is received through a second interface, wherein the second interface being configured to prompt the user to touch the touch screen by the target palm in the completely stretched state.

When the device detects that the natural position correlations and the maximal position correlations are not stored, the device may display the second interface, which is configured to prompt the user to touch the touch screen by the target palm in the completely stretched state.

Secondly, relative position correlations between the palm heel and respective fingers when the target palm touches the touch screen in the completely stretched state are determined based on the second touch signal, and the relative position correlations determined based on the second touch signal are set as the maximal position correlations.

After receiving the second touch signal, the device determines, based on the second touch signal, relative position correlations between the palm heel and respective fingers when the target palm touches the touch screen in the completely stretched state, and sets the relative position correlations determined based on the second touch signal as the maximal position correlations.

It is to be noted that the device obtains the maximal position correlations in an obtaining manner similar to that for the device to obtain the position correlations between the palm heel and respective fingers when the user's palm touches the touch screen in the completely stretched state in step 202, for the technical details please refer to step 202, which will not be redundantly described here.

It is to be further noted that when the device obtains the natural position correlations and the maximal position correlations, the user's palm may be away from the touch screen, and when the user uses his palm to touch the touch screen again to request inputting, positions of respective fingers of the user's palm on the touch screen are no longer the initial positions obtained in step 204, so the device performs step 204 again after obtaining the natural position correlations and the maximal position correlations, the technical details will not be redundantly described in the present embodiment.

In step 209, a relative position of the basic key button position and other key button positions corresponding to each finger is constructed based on a preset order between the basic key button position of the basic key button corresponding to each finger and other key button positions of other key buttons corresponding to each finger, natural position correlations between a palm heel of the target palm and respective fingers, and maximal position correlations between the palm heel of the target palm and respective fingers.

Similarly to the case where the user conducts inputting on a physical keyboard, each finger of the user will correspond to and input several constant characters, e.g., the index finger of left hand may input ‘f’, ‘g’, ‘v’, ‘b’, ‘r’ ‘t’, ‘4’ and ‘5’, and the order among respective characters is constant, so each finger corresponds to several different key button positions in a preset order, for detailed diagram of which please refer to FIG. 2G. Therefore, the device may construct the relative position between the basic key button position and other key button positions corresponding to each finger, based on the preset order between the basic key button position of the basic key button corresponding to each finger and other key button positions of other key buttons corresponding to each finger, natural position correlations between the palm heel of the target palm and respective fingers, and maximal position correlations between the palm heel of the target palm and respective fingers.

In actual implementation, among the maximal position correlations, the device may construct the farthest position that can be reached by each finger as a key button position of a key button farthest away from the basic key button position of the basic key button among respective key buttons corresponding to the finger. For example, it can be known from FIG. 2G that the key button position corresponding to character ‘5’ is farthest away from the basic key button position of the basic key button ‘f’ corresponding to the index finger on the touch screen, so the device may set, among the maximal position correlations, the farthest position that can be reached by the index finger as the key button position corresponding to character ‘5’, and continue to construct based on a preset order among other key button positions corresponding to the index finger and ‘f’ and ‘5’, and thus determine the relative positions among respective key button positions corresponding to each finger on the touch screen.

In step 210, a tap signal is received through the touch screen.

When the user taps a certain area on the touch screen, the device may receive the tap signal through the touch screen.

In step 211, a touch position of a target finger is detected based on the tap signal.

The device may determine the touch position of the target finger based on the received tap signal. In actual implementation, the device may determine the position where the tap signal is received as the touch position of the target finger. The target finger is the finger applying the tap signal.

In step 212, a target key button position corresponding to the target finger at the touch position is determined based on a displacement between an initial position and the touch position of the target finger, a basic key button position of a basic key button corresponding to the target finger at the initial position, and a relative position between the basic key button position and other key button positions of other key buttons corresponding to the target finger on the touch screen.

The device determines the target key button position by the following steps.

Firstly, a fingerprint of the target finger is obtained after the tap signal is received.

After receiving the tap signal, the device may obtain the fingerprint of the target finger which generates the tap signal. The device obtains the fingerprint of the target finger in an obtaining manner similar to that for the device to obtain the palm print in step 201, for technical details please refer to the step 201, which will not be redundantly described here.

Secondly, the initial position of the target finger is retrieved based on the fingerprint of the target finger.

Because the device has determined the initial position of each finger of the target palm in step 204, so after determining the fingerprint of the target finger, the device may inquire the initial position of the target finger based on the fingerprint of the target finger.

In actual implementation, the device retrieves the initial position of the target finger based on the fingerprint of the target finger by a retrieving manner, which may include any one of the following manners.

In a first manner, the natural position correlations are obtained based on the fingerprint of the target finger, and the initial position of the fingerprint of the target finger are determined based on the start position of the palm print of the palm heel on the touch screen and the natural position correlations.

Because fingerprints may be used to identify respective fingers in the natural position correlations, so after obtaining the fingerprint of the target finger, the device may obtain the natural position correlations, and after finding the natural position correlations, the device may inquire, by retrieving the natural position correlations, the initial position of the target finger on the touch screen when the palm heel is placed at the start position.

In a second manner, the initial position of the target finger is directly retrieved based on the fingerprint of the target finger.

Corresponding to the second determining manner for the device to determine the initial position of each finger of the target palm, after obtaining the fingerprint of the target finger, the device may directly retrieve the initial position corresponding to the fingerprint of the target finger.

Thirdly, the displacement between the initial position and the touch position of the target finger is calculated.

Fourthly, the target key button position corresponding to the target finger at the touch position is determined based on the displacement, the basic key button position of the basic key button corresponding to the target finger, and the relative position of the basic key button position and other key button positions of other key buttons corresponding to the target finger on the touch screen.

Because the basic key button position of the basic key button corresponding to the target finger at the initial position has been determined, and the relative position on the touch screen of the basic key button position of the basic key button and other key button positions of other key buttons corresponding to the target finger has also been determined, so after obtaining the displacement, the device may determine the target key button position corresponding to the target finger at the touch position.

In step 213, a target character corresponding to the target key button position is inputted.

After determining the target key button position, the device may input the target character corresponding to the target key button position. For example, when the target key button position determined by the electronic device is the key button position of ‘t’, the device may input the target character ‘t’.

In sum, after the tap signal is received, the method for inputting provided by the present embodiment proceeds to detect the touch position of a target finger based on the tap signal, and then determine the target key button position corresponding to the target finger at the touch position based on the displacement between the initial position and the touch position of the target finger, the basic key button position of the basic key button corresponding to the target finger at the initial position, and the relative position of the basic key button position and other key button positions of other key buttons corresponding to the target finger on the touch screen, and thus input a target character corresponding to the target key button position, so as to solve the low input accuracy and slow input speed problems in the related art, and to achieve the following effects. Even if the placement position of the user's hands deviates from that in the user's normal use, because the target key button position is determined based on the displacement between the initial position and the touch position of the target finger, the device still may input the user's desired character accurately, such that the input accuracy may be improved; meanwhile, since the target key button position is determined based on the displacement between the initial position and the touch position of the target finger, the user may conduct inputting on the touch screen according to his own touch-type habit in the physical keyboard, without viewing the virtual keyboard on the touch screen, and thus achieving the effect of improving the input speed.

Meanwhile, in the present embodiment, before constructing the relative positions on the touch screen among key button positions of respective key buttons corresponding to each finger, whether the natural position correlations and the maximal position correlations have been stored in the device is detected in advance, such that when the detecting result is that the natural position correlations and the maximal position correlations are not stored, the natural position correlations and the maximal position correlations can be firstly inputted by the user, and then constructing is performed when the user requests inputting once again, so as to solve the following problem: when the user requesting to input changes, the device cannot construct the relative positions on the touch screen among key button positions of respective key buttons corresponding to each finger, so the device cannot determine the target key button position corresponding to the touch position of the target finger, thus the target character cannot be inputted.

Referring to FIG. 2H, it is to be noted that before performing step 212, the device may perform the following steps S214-S215 in order to avoid the following problem. After the user generates the touch signal and before the user generates the tap signal, the position of the user palm on the touch screen deviates, such that the initial position of the target finger, when the user generates the tap signal, is no longer the position of the target finger when the user generates the touch signal, then the target key button position determined by the device based on the initial position of the target finger is no longer the target key button position that the user actually requests to tap, that is, the target character eventually inputted by the device is not the character that the user actually requests to input.

In step 214, a current position of the palm heel of the target palm on the touch screen is obtained.

In order to perform subsequent steps, the device may obtain the current position of the palm heel of the target palm on the touch screen. In actual implementation, the device may detect the touch position of the palm print of the target palm on the touch screen, and regard the detected touch position as the current position of the palm heel of the target palm on the touch screen.

In step 215, it is detected whether the current position of the palm heel matches with the start position of the palm heel of the target palm when the device receives the touch signal.

In order to determine whether the position of the palm heel changes, the device may detect whether the current position of the palm heel matches with the start position of the palm heel of the target palm when the device receives the touch signal.

Accordingly, in step 212, when the detecting result is “matching”, the device is configured to perform the following step: a target key button position corresponding to the target finger at the touch position is determined based on a displacement between an initial position and the touch position of the target finger, a basic key button position of a basic key button corresponding to the target finger at the initial position, and a relative position between the basic key button position and other key button positions of other key buttons corresponding to the target finger on the touch screen.

If the detecting result of the device is “matching”, it is indicated that the position of the palm heel does not change, i.e., the initial position of the target finger does not change, then the device may directly perform step 212.

If the detecting result of the device is “not matching”, it is indicated that the position of the palm heel has changed; then, in order to avoid the problem that the target key button position determined by the device is not the key button position that the user actually needs to tap, i.e., the target character actually inputted by the device is not the character that the user actually wants to input, the device will go to step 204 again, so as to re-determine the initial position of the target finger, and the technical details will not be redundantly described in the present embodiment.

Apparatus embodiments of the present disclosure, which may be configured to perform the method embodiments of the present disclosure, are set forth below. As to the undisclosed details of the apparatus embodiments of the present disclosure, please refer to the method embodiments of the present disclosure.

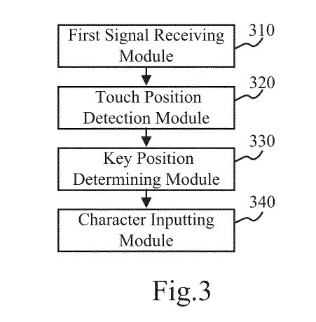

FIG. 3 is a diagram showing an apparatus for inputting according to an exemplary embodiment. As shown in FIG. 3, the apparatus may include but not limited to: a first signal receiving module 310, a touch position detection module 320, a key button position determining module 330 and a character inputting module 340.

The first signal receiving module 310 is configured to receive a tap signal through the touch screen.

The touch position detection module 320 is configured to detect a touch position of a target finger based on the tap signal received by the first signal receiving module 310.

The key button position determining module 330 is configured to determine a target key button position corresponding to the target finger at the touch position, based on a displacement between an initial position and the touch position of the target finger, a basic key button position of a basic key button is corresponding to the target finger at the initial position, and a relative position on the touch screen of the basic key button position and other key button positions of other key buttons is corresponding to the target finger.

The character inputting module 340 is configured to input a target character corresponding to the target key button position determined by the key button position determining module 330.

In sum, after receiving the tap signal, the apparatus provided by the present embodiment detects the touch position of a target finger based on the tap signal, and determines the target key button position corresponding to the target finger at the touch position based on the displacement between the initial position and the touch position of the target finger, the basic key button position of the basic key button corresponding to the target finger at the initial position, and the relative position of the basic key button position and other key button positions of other key buttons corresponding to the target finger on the touch screen, and thus inputs a target character corresponding to the target key button position, so as to solve the low input accuracy and slow input speed problems in the related art, and to achieve the following effects. Even if the placement position of the user's hands deviates from that in the user's normal use, because the target key button position is determined based on the displacement between the initial position and the touch position of the target finger, the device still may input the user's desired character accurately, such that the input accuracy may be improved; meanwhile, since the target key button position is determined based on the displacement between the initial position and the touch position of the target finger, the user may conduct inputting on the touch screen according to his own touch-type habit in the physical keyboard, without viewing the virtual keyboard on the touch screen, and thus achieving the effect of improving the input speed.

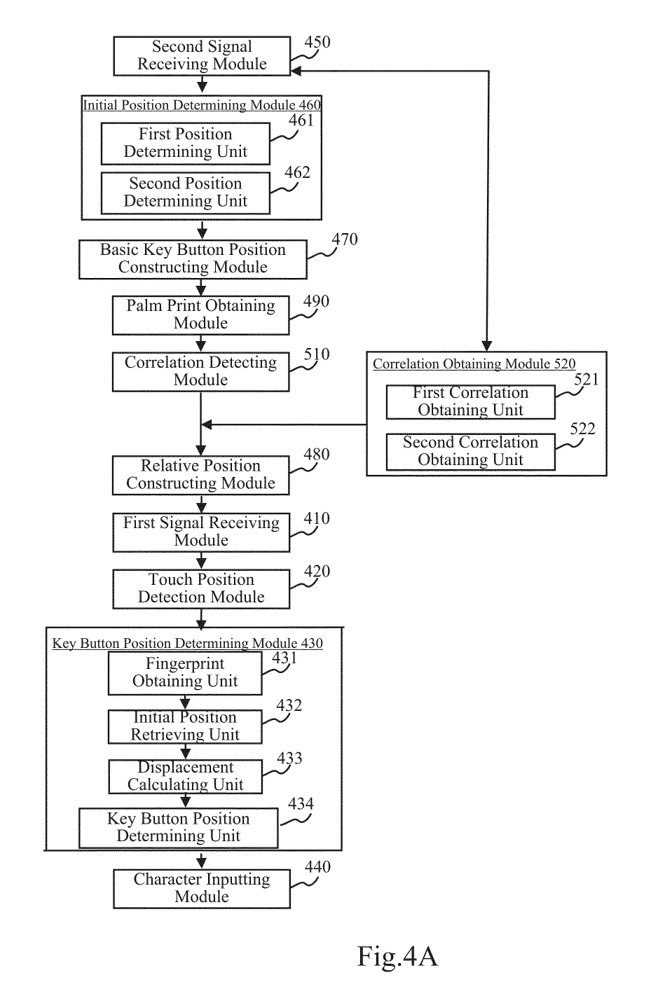

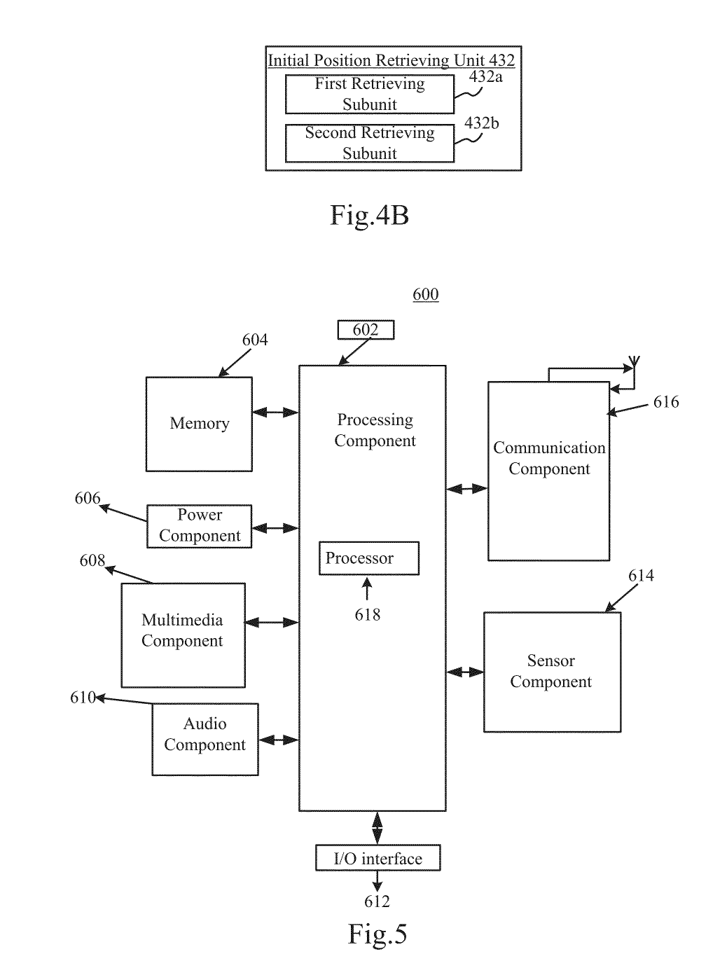

FIG. 4A is a diagram showing an apparatus for inputting according to an exemplary embodiment. As shown in FIG. 4A, the apparatus may include but not limited to: a first signal receiving module 410, a touch position detection module 420, a key button position determining module 430 and a character inputting module 440.

The first signal receiving module 410 is configured to receive a tap signal through the touch screen.

The touch position detection module 420 is configured to detect a touch position of a target finger based on the tap signal received by the first signal receiving module 410.

The key button position determining module 430 is configured to determine a target key button position corresponding to the target finger at the touch position, based on a displacement between an initial position and the touch position of the target finger, a basic key button position of a basic key button is corresponding to the target finger at the initial position, and a relative position of the basic key button position and other key button positions of other key buttons is corresponding to the target finger on the touch screen.

The character inputting module 440 is configured to input a target character corresponding to the target key button position determined by the key button position determining module 430.

A first possible implementation of the embodiment shown in FIG. 4A is as follows.

A second signal receiving module 450 is configured to receive a touch signal through the touch screen.

An initial position determining module 460 is configured to determine an initial position of each finger of a target palm on the touch screen based on the touch signal received by the second signal receiving module 450.

A basic key button position constructing module 470 is configured to construct the initial position of each finger on the touch screen as a basic key button position of a basic key button corresponding to the finger.

A relative position constructing module 480 is configured to construct a relative position of the basic key button position and other key button positions corresponding to each finger, based on a preset order between the basic key button position of the basic key button corresponding to each finger and other key button positions of other key buttons corresponding to each finger, natural position correlations between a palm heel of the target palm and respective fingers, and maximal position correlations between the palm heel of the target palm and respective fingers.

The natural position correlations are relative position correlations between the palm heel and respective fingers when the target palm touches the touch screen in a naturally typing state.

The maximal position correlations are relative position correlations between the palm heel and respective fingers when the target palm touches the touch screen in a completely stretched state.

In a second possible implementation of the embodiment shown in FIG. 4A, the initial position determining module 460 includes: a first position determining unit 461 or a second position determining unit 462.

The first position determining unit 461 is configured, when a palm print is used to identify the palm heel and fingerprints are used to identify respective fingers in the natural position correlations, to obtain a palm print of the palm heel based on the touch signal and determine a start position of the palm print on the touch screen; and then configured to obtain the natural position correlations corresponding to the palm print; and to determine the initial position of each finger on the touch screen based on the start position of the palm print on the touch screen and the natural position correlations.

The second position determining unit 462 is configured, when fingerprints are used to identify respective fingers in the natural position correlations and/or the maximal position correlations, and to obtain different fingerprints based on the touch signal after receiving the touch signal; and then configured to identify each finger based on the separate fingerprints, and to determine the initial position of each finger on the touch screen based on a position of each fingerprint in the touch signal.

In a third possible implementation of the embodiment shown in FIG. 4A, the key button position determining module 430 includes: a fingerprint obtaining unit 431 configured to obtain a fingerprint of the target finger after receiving the tap signal; an initial position retrieving unit 432 configured to retrieve the initial position of the target finger based on the fingerprint of the target finger; a displacement calculating unit 433 configured to calculate the displacement between the initial position and the touch position of the target finger; and a key button position determining unit 434 configured to determine the target key button position corresponding to the target finger at the touch position, based on the displacement, the basic key button position of the basic key button is corresponding to the target finger, and the relative position on the touch screen of the basic key button position and other key button positions of other key buttons is corresponding to the target finger.

Referring to FIG. 4B, in a fourth possible implementation of the embodiment shown in FIG. 4A, the initial position retrieving unit 432 includes: a first retrieving subunit 432a or a second retrieving subunit 432b.

The first retrieving subunit 432a is configured to obtain the natural position correlations based on the fingerprint of the target finger, and to determine the initial position of the fingerprint of the target finger based on the start position of the palm print of the palm heel on the touch screen and the natural position correlations.

The second retrieving subunit 432b is configured to directly retrieve the initial position of the fingerprint of the target finger based on the fingerprint of the target finger.

In a fifth possible implementation of the embodiment shown in FIG. 4A, the apparatus further includes: a palm print obtaining module 490 configured, when a palm print is used to identify the palm heel in the natural position correlations and the maximal position correlations, to obtain a palm print of the palm heel after receiving the touch signal; a correlation detecting module 510 configured to detect whether the natural position correlations and the maximal position correlations have been stored, based on the palm print of the palm heel obtained by the palm print obtaining module 490; and a correlation obtaining module 520 configured, when a detecting result of the correlation detecting module 510 is that the natural position correlations and the maximal position correlations are not stored, to obtain the natural position correlations and the maximal position correlations.

In a sixth possible implementation of the embodiment shown in FIG. 4A, the correlation obtaining module 520 includes: a first correlation obtaining unit 521 and a second correlation obtaining unit 522.

The first correlation obtaining unit 521 is configured to receive a first touch signal through a first interface, which is configured to prompt a user to touch the touch screen by the target palm in a naturally typing state; and then configured to determine, based on the first touch signal, relative position correlations between the palm heel and respective fingers when the target palm touches the touch screen in the naturally typing state; and configured to serve the relative position correlations determined based on the first touch signal as the natural position correlations.

The second correlation obtaining unit 522 is configured to receive a second touch signal through a second interface, which is configured to prompt the user to touch the touch screen by the target palm in a completely stretched state; and then configured to determine, based on the second touch signal, relative position correlations between the palm heel and respective fingers when the target palm touches the touch screen in the completely stretched state; and configured to serve the relative position correlations determined based on the second touch signal as the maximal position correlations.

In sum, after receiving the tap signal, the apparatus for inputting provided by the present embodiment detects the touch position of a target finger based on the tap signal, and determines the target key button position corresponding to the target finger at the touch position based on the displacement between the initial position and the touch position of the target finger, the basic key button position of the basic key button corresponding to the target finger at the initial position, and the relative position of the basic key button position and other key button positions of other key buttons corresponding to the target finger on the touch screen, and thus inputs a target character corresponding to the target key button position, so as to solve the low input accuracy and slow input speed problems in the related art, and to achieve the following effects. Even if the placement position of the user's hands deviates from that in the user's normal use, because the target key button position is determined based on the displacement between the initial position and the touch position of the target finger, the device still may input the user's desired character accurately, such that the input accuracy may be improved; meanwhile, since the target key button position is determined based on the displacement between the initial position and the touch position of the target finger, the user may conduct inputting on the touch screen according to his own touch-type habit in the physical keyboard, without viewing the virtual keyboard on the touch screen, and thus achieving the effect of improving the input speed.

FIG. 5 is a diagram showing a device 600 for inputting according to an exemplary embodiment. For example, the device 600 may be a mobile phone, a computer, a digital broadcast terminal, a messaging device, a gaming console, a tablet, a medical device, an exercise equipment, a personal digital assistant, and the like.

Referring to FIG. 5, the device 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 618 to execute instructions to perform all or part of the steps in the above-described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, and so on. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power supplies, and other components associated with the generation, management, and distribution of power in the device 600.

The multimedia component 608 includes a screen providing an output interface between the device 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (MIC) configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a key board, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600, relative positioning of components, e.g., the display and the key pad, of the device 600, a change in position of the device 600 or a component of device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 2G, or 3G, or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 604, executable by the processor 618 in the device 600, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and embodiments be considered as exemplary only, with a true scope and concept of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for inputting using a touch screen, comprising:
receiving a tap signal through the touch screen;
detecting a touch position of a target finger based on the tap signal;
determining a target key button position corresponding to the target finger at the touch position, based on a displacement between an initial position and the touch position of the target finger, a basic key button position of a basic key button corresponding to the target finger at the initial position, and a relative position of the basic key button position and other key button positions of other key buttons corresponding to the target finger on the touch screen; and
inputting a target character corresponding to the target key button position.

2. The method according to claim 1, further comprising:
receiving a touch signal through the touch screen;
determining an initial position of each finger of a target palm on the touch screen based on the touch signal;
constructing the initial position of each finger on the touch screen as a basic key button position of a basic key button corresponding to the finger; and
constructing a relative position of the basic key button position and other key button positions corresponding to each finger, based on a preset order between the basic key button position of the basic key button corresponding to each finger and other key button positions of other key buttons corresponding to each finger, natural position correlations between a palm heel of the target palm and respective fingers, and maximal position correlations between the palm heel of the target palm and respective fingers.

3. The method according to claim 2, wherein the natural position correlations are relative position correlations between the palm heel and respective fingers when the target palm touches the touch screen in a naturally typing state; and the maximal position correlations are relative position correlations between the palm heel and respective fingers when the target palm touches the touch screen in a completely stretched state.

4. The method according to claim 3, wherein determining the initial position of each finger of the target palm on the touch screen based on the touch signal comprises:
obtaining a palm print of the palm heel based on the touch signal if the palm heel is identified by the palm print and fingers are identified by fingerprints in the natural position correlations;
determining a start position of the palm print on the touch screen;
obtaining the natural position correlations corresponding to the palm print; and
determining the initial position of each finger on the touch screen based on the start position of the palm print on the touch screen and the natural position correlations.

5. The method according to claim 3, wherein determining the initial position of each finger of the target palm on the touch screen based on the touch signal further comprises:
obtaining separate fingerprints based on the touch signal after the touch signal is received if separate fingers are identified by fingerprints in the natural position correlations and the maximal position correlations;
identifying each finger based on the separate fingerprints; and
determining the initial position of each finger on the touch screen based on a position of each fingerprint in the touch signal.

6. The method according to claim 4, wherein determining the target key button position corresponding to the target finger at the touch position comprises:
obtaining a fingerprint of the target finger after the tap signal is received;
retrieving the initial position of the target finger based on the fingerprint of the target finger;
calculating the displacement between the initial position and the touch position of the target finger; and
determining the target key button position corresponding to the target finger at the touch position, based on the displacement, the basic key button position of the basic key button corresponding to the target finger, and the relative position on the touch screen of the basic key button position and other key button positions of other key buttons corresponding to the target finger.

7. The method according to claim 6, wherein retrieving the initial position of the target finger based on the fingerprint of the target finger comprises:
obtaining the natural position correlations based on the fingerprint of the target finger; and
determining the initial position of the fingerprint of the target finger based on the start position of the palm print of the palm heel on the touch screen and the natural position correlations.

8. The method according to claim 6, wherein the initial position of the target finger can be retrieved directly based on the fingerprint of the target finger.

9. The method according to claim 2, further comprising:
obtaining a palm print of the palm heel after the touch signal is received if the palm heel is identified by the palm print in the natural position correlations and the maximal position correlations;
detecting whether the natural position correlations and the maximal position correlations corresponding to the palm print have been stored, based on the palm print of the palm heel; and
obtaining the natural position correlations and the maximal position correlations if the natural position correlations and the maximal position correlations are detected to have not been stored.

10. The method according to claim 9, wherein obtaining the natural position correlations and the maximal position correlations comprises:
receiving a first touch signal through a first interface, which is configured to prompt a user to touch the touch screen by the target palm in the naturally typing state;
determining, based on the first touch signal, relative position correlations between the palm heel and respective fingers when the target palm touches the touch screen in the naturally typing state;
setting the relative position correlations determined based on the first touch signal as the natural position correlations;
receiving a second touch signal through a second interface, which is configured to prompt the user to touch the touch screen by the target palm in the completely stretched state;
determining, based on the second touch signal, relative position correlations between the palm heel and respective fingers when the target palm touches the touch screen in the completely stretched state; and
setting the relative position correlations determined based on the second touch signal as the maximal position correlations.

11. A device for inputting using a touch screen, comprising:
a processor; and
a memory for storing instructions executable by the processor, wherein the processor is configured to perform:
receiving a tap signal through the touch screen;
detecting a touch position of a target finger based on the tap signal;
determining a target key button position corresponding to the target finger at the touch position, based on a displacement between an initial position and the touch position of the target finger, a basic key button position of a basic key button corresponding to the target finger at the initial position, and a relative position of the basic key button position and other key button positions of other key buttons corresponding to the target finger on the touch screen; and
inputting a target character corresponding to the target key button position.

12. The device according to claim 11, wherein the processor is configured to further perform:
receiving a touch signal through the touch screen;
determining an initial position of each finger of a target palm on the touch screen based on the touch signal;
constructing the initial position of each finger on the touch screen as a basic key button position of a basic key button corresponding to the finger; and
constructing a relative position of the basic key button position and other key button positions corresponding to each finger, based on a preset order between the basic key button position of the basic key button corresponding to each finger and other key button positions of other key buttons corresponding to each finger, natural position correlations between a palm heel of the target palm and respective fingers, and maximal position correlations between the palm heel of the target palm and respective fingers.

13. The device according to claim 12, wherein the natural position correlations are relative position correlations between the palm heel and respective fingers when the target palm touches the touch screen in a naturally typing state; and the maximal position correlations are relative position correlations between the palm heel and respective fingers when the target palm touches the touch screen in a completely stretched state.

14. The device according to claim 13, wherein determining the initial position of each finger of the target palm on the touch screen based on the touch signal comprises:
obtaining a palm print of the palm heel based on the touch signal if the palm heel is identified by the palm print and fingers are identified by fingerprints in the natural position correlations;
determining a start position of the palm print on the touch screen;
obtaining the natural position correlations corresponding to the palm print; and
determining the initial position of each finger on the touch screen based on the start position of the palm print on the touch screen and the natural position correlations.

15. The device according to claim 13, wherein determining the initial position of each finger of the target palm on the touch screen based on the touch signal further comprises:
obtaining separate fingerprints based on the touch signal after the touch signal is received if the fingers are identified by fingerprints in the natural position correlations and the maximal position correlations;
identifying each finger based on the separate fingerprints; and
determining the initial position of each finger on the touch screen based on a position of each fingerprint in the touch signal.

16. The method according to claim 14, wherein determining a target key button position corresponding to the target finger at the touch position comprises:
obtaining a fingerprint of the target finger after the tap signal is received;
retrieving the initial position of the target finger based on the fingerprint of the target finger;
calculating the displacement between the initial position and the touch position of the target finger; and
determining the target key button position corresponding to the target finger at the touch position, based on the displacement, the basic key button position of the basic key button corresponding to the target finger, and the relative position on the touch screen of the basic key button position and other key button positions of other key button buttons corresponding to the target finger.

17. The method according to claim 16, wherein retrieving the initial position of the target finger based on the fingerprint of the target finger comprises:
obtaining the natural position correlations based on the fingerprint of the target finger; and
determining the initial position of the fingerprint of the target finger based on the start position of the palm print of the palm heel on the touch screen and the natural position correlations.

18. The device according to claim 17, wherein the initial position of the target finger can be retrieved directly based on the fingerprint of the target finger.

19. The device according to 12, wherein the processor is configured to further perform:
obtaining a palm print of the palm heel after the touch signal is received if the palm heel is identified by the palm print in the natural position correlations and the maximal position correlations;
detecting whether the natural position correlations and the maximal position correlations corresponding to the palm print have been stored, based on the palm print of the palm heel; and
obtaining the natural position correlations and the maximal position correlations if the natural position correlations and the maximal position correlations are detected to have not been stored.

20. The device according to claim 19, wherein obtaining the natural position correlations and the maximal position correlations comprises:
receiving a first touch signal through a first interface, which is configured to prompt a user to touch the touch screen by the target palm in the naturally typing state;
determining, based on the first touch signal, relative position correlations between the palm heel and respective fingers when the target palm touches the touch screen in the naturally typing state;
setting the relative position correlations determined based on the first touch signal as the natural position correlations;
receiving a second touch signal through a second interface, which is configured to prompt the user to touch the touch screen by the target palm in the completely stretched state;
determining, based on the second touch signal, relative position correlations between the palm heel and respective fingers when the target palm touches the touch screen in the completely stretched state; and
setting the relative position correlations determined based on the second touch signal as the maximal position correlations.

21. A non-transitory computer-readable storage medium having stored therein instructions that, when executed by a processor of a device, causes the device to perform an method for inputting, the method comprising:
receiving a tap signal through the touch screen;
detecting a touch position of a target finger based on the tap signal;
determining a target key button position corresponding to the target finger at the touch position, based on a displacement between an initial position and the touch position of the target finger, a basic key button position of a basic key button corresponding to the target finger at the initial position, and a relative position of the basic key button position and other key button positions of other key buttons corresponding to the target finger on the touch screen; and
inputting a target character corresponding to the target key button position.
